(19) United States
(12) Patent Application Publication
(10) Pub. No.: US 2026/0109210 A1
(43) Pub. Date: Apr. 23, 2026

(54) Aluminum Roll Cover and a Pickup Truck with the Aluminum Roll Cover

(71) Applicant: Wenzhou Tianmao Automobile Parts Co.,Ltd, Wenzhou City (CN)

(72) Inventors: Lanhua Cai, Wenzhou City (CN); Yonggen Cai, Wenzhou City (CN); Xianzu Chen, Wenzhou City (CN)

(21) Appl. No.: 19/024,267

(22) Filed: Jan. 16, 2025

(30) Foreign Application Priority Data
Oct. 18, 2024 (CN) 202411459098.7

(51) Int. Cl. B60J 7/08; B60J 7/185; B60J 10/90

(52) U.S. Cl. CPC B60J 7/085; B60J 10/90; B60J 7/185

(57) ABSTRACT

The present invention discloses an aluminum roll cover and a pickup truck equipped with the aluminum roll cover. It comprises a front cover, an intermediate profile rubber strip assembly, a tailgate, a latch bolt system, a clip system, a guide rail system and a storage box. By providing the storage box, the present invention can roll up the intermediate profile rubber strip assembly, facilitating the storage of the roll cover.

### CROSS REFERENCE TO RELATED APPLICATION

This application claims priority benefit of Chinese patent Application No. 202411459098.7, filed on Oct. 18, 2024, and the entire contents of which are incorporated herein by reference.

### TECHNICAL FIELD

The present invention belongs to the field of pickup truck covers, specifically relating to an aluminum roll cover.

### BACKGROUND

Pickup trucks are an important part of the automobile market. A pickup truck is a vehicle type that adopts a car front end and a cab while having an open cargo compartment. It is characterized by having both the comfort of a car and strong power, and it also has stronger capabilities in carrying goods and adapting to poor road conditions than a car. The most common pickup truck model is the double-cab pickup truck. Pickup trucks can be used as special-purpose vehicles, multi-purpose vehicles, official vehicles, and commercial vehicles, and can also be used as family vehicles for carrying goods, traveling, renting, etc. The so-called “pickup truck” is a hybrid of a car and a truck. With the expansion of the scale of modification enthusiasts, pickup truck modification is increasingly becoming a popular category among modification enthusiasts.

Existing pickup truck covers are divided into soft covers and hard covers. Compared with hard covers, soft covers can be opened more widely. However, when using soft covers, the following problems usually exist:
1. Different from the folding of hard covers, most soft covers are opened by rolling up. In this way, during the use process, the rolled-up soft cover is not convenient to place, which causes inconvenience in transporting some taller goods for pickup trucks with soft covers.
2. Since the soft cover is composed of multiple profiles spliced together, how to handle the waterproofing between the profiles is the key to the quality of the soft cover.
3. The soft cover needs to be rolled up frequently. How to design it so that the soft cover does not become loose after multiple roll-ups is also a problem to be solved in this application.

### CONTENTS OF THE INVENTION

To solve the above problems existing in the prior art, the technical scheme adopted by the present invention is as follows:

An aluminum roll cover, it comprises a front cover, an intermediate profile rubber strip assembly, a tailgate, a latch bolt system, a clip system, a guide rail system and a storage box;

The front cover is arranged on the upper side of the storage box. The latch bolt system is connected to the front cover. The intermediate profile rubber strip assembly is connected to the storage box. The tailgate is connected to the tail of the intermediate profile rubber strip assembly. The latch bolt system is connected to the tailgate. The guide rail system is connected with a clip system, and the clip system is used to clamp the body of the pickup truck and the guide rail system;

The guide rail system includes a guide rail rear joint. The guide rail rear joint is provided with a lock groove of the rear joint of the guide rail. The guide rail rear joint locking groove is used to cooperate with the latch bolt system. The latch bolts of the latch bolt system are distributed at both ends, and at least one latch bolt is provided with a chamfered structure.

When the latch bolt system snaps into the locking groove of the guide rail rear joint, the truck cover is locked. When the latch bolt system leaves the locking groove of the guide rail rear joint, the truck cover is unlocked and opened.

By setting a storage box, the intermediate profile rubber strip assembly can be rolled up, facilitating the storage of the roll cover.

By setting the locking groove of the guide rail rear joint in the guide rail system, the latch bolt system can be snapped into the locking groove of the guide rail rear joint, facilitating the connection of the tailgate. Since the tailgate needs to be opened and closed frequently, this connection method not only facilitates the opening and closing of the tailgate but also makes the connection of the tailgate stable.

An aluminum roll cover, it comprises a front cover, an intermediate profile rubber strip assembly, a tailgate, a latch bolt system, a clip system, a guide rail system and a storage box;

The front cover is arranged on the upper side of the storage box. The latch bolt system is connected to the front cover. The intermediate profile rubber strip assembly is connected to the storage box. The tailgate is connected to the tail of the intermediate profile rubber strip assembly. The latch bolt system is connected to the tailgate. The guide rail system is connected with a clip system, and the clip system is used to clamp the body of the pickup truck and the guide rail system;

The guide rail system includes a guide rail and a guide rail rear joint. The guide rail is provided with a guide rail C-profile, an internal drainage hole of the guide rail, and an external drainage hole of the guide rail. The internal drainage hole of the guide rail and the external drainage hole of the guide rail are used for drainage. The guide rail rear joint is provided with a guide rail rear joint locking groove and a guide rail rear joint insertion block. The guide rail rear joint insertion block is connected to the guide rail C-profile. The guide rail rear joint locking groove is used to cooperate with the latch bolt system.

When the latch bolt system snaps into the locking groove of the guide rail rear joint, the truck cover is locked. When the latch bolt system leaves the locking groove of the guide rail rear joint, the truck cover is unlocked and opened.

By setting the internal drainage holes and the external drainage holes of the guide rail, the water inside the guide rail can be drained in a timely manner. Additionally, by connecting the insertion block of the guide rail rear joint with the C-profile of the guide rail, the stability of the connection of the guide rail rear joint can be improved.

An aluminum roll cover, it comprises a front cover, an intermediate profile rubber strip assembly, a tailgate, a latch bolt system, a clip system, a guide rail system and a storage box;

The front cover is arranged on the upper side of the storage box. The latch bolt system is connected to the front cover. The intermediate profile rubber strip assembly is connected to the storage box. The tailgate is connected to the tail of the intermediate profile rubber strip assembly. The latch bolt system is connected to the tailgate. The guide rail system is connected with a clip system, and the clip system is used to clamp the body of the pickup truck and the guide rail system;

The guide rail system includes a guide rail, a guide rail rear joint, a lower sliding strip, an upper blocking waterproof rubber strip and a lower blocking waterproof rubber strip. The guide rail is provided with a guide rail first slot, a guide rail second slot, a guide rail support plane, a guide rail channel and a guide rail C-profile. The guide rail rear joint is provided with a guide rail rear joint insertion block. The guide rail rear joint insertion block is connected to the guide rail C-profile. The guide rail second slot is connected with an upper blocking waterproof rubber strip. The guide rail first slot is connected with a lower sliding strip. The guide rail support plane is connected with a lower blocking waterproof rubber strip. The lower blocking waterproof rubber strip and the guide rail support plane form a guide rail channel.

By setting the lower sliding strip, using the lower sliding strip to support the intermediate profile rubber strip assembly, and through the design of the structure of the lower sliding strip, the intermediate profile rubber strip assembly and the lower sliding strip maintain line contact, thereby ensuring the smooth sliding of the intermediate profile rubber strip assembly. Secondly, by setting the lower blocking waterproof rubber strip, concentrating the rainwater in the guide rail channel can play a good waterproof role.

Furthermore, the upper blocking waterproof rubber strip includes a rubber strip bottom and a rubber strip tip. The rubber strip bottom is engaged with the guide rail second slot. The rubber strip tip is used for waterproofing;

The intermediate profile rubber strip assembly includes multiple intermediate profiles. The lower sliding strip further includes a lower sliding strip snapping protrusion and a lower sliding strip contact point. The lower sliding strip snapping protrusion is engaged with the guide rail first slot. The lower sliding strip contact point abuts against the intermediate profile and is used for slidingly supporting the vehicle cover. The contact between the lower sliding strip contact point and the intermediate profile is a line contact;

The lower blocking waterproof rubber strip is connected to the guide rail support plane. The lower blocking waterproof rubber strip is used to prevent water from flooding into the interior of the vehicle cover from the guide rail channel.

Since the lower sliding strip is to support the intermediate profile rubber strip assembly and serves as a transition piece between the guide rail and the intermediate profile rubber strip assembly, with one side being the fixed guide rail and the other side being the sliding intermediate profile rubber strip assembly, in order to ensure the stability of the connection of the lower sliding strip, a protrusion for the lower sliding strip to snap into is specially set at its bottom. In this way, the lower sliding strip is not easy to fall off after being snapped into the first slot of the guide rail, thus prolonging the service life.

In addition, an upper blocking waterproof rubber strip is also set on the upper side of the intermediate profile rubber strip assembly, and the upper blocking waterproof rubber strip has a rubber strip tip protruding towards the intermediate profile rubber strip assembly. The rubber strip tip abuts against the intermediate profile rubber strip assembly, which can play a good waterproof effect.

Furthermore, the guide rail system includes a guide rail. The guide rail includes a guide rail support plane, an internal drainage hole of the guide rail and an external drainage hole of the guide rail. The internal drainage hole of the guide rail and the external drainage hole of the guide rail are both arranged on the upper side of the guide rail support plane.

The guide rail system includes the C-profile of the guide rail connected to the body of the pickup truck at the lower part, and also includes the upper half part for its waterproofing and supporting functions. Through the improvement of the overall cross-section of the guide rail system, it has both the functions of connection and waterproofing.

Furthermore, the guide rail includes an internal drainage hole of the guide rail. The guide rail rear joint is provided with a guide rail joint second insertion block. The guide rail joint second insertion block is connected to the guide rail, it is used to seal the end of the guide rail.

Furthermore, the latch bolt system includes a latch bolt, a first lock base, a steel wire, a locking system pull rope, a lock fixing block, a second lock base and a locking block.

Both the latch bolt and the locking block are connected to the guide rail rear joint locking groove. The latch bolt, the first lock base, the locking system pull rope and the lock fixing block are connected in series by the steel wire, the pull rope of the locking system is pulled, the latch bolt and the latch block can be opened.

The tailgate is provided with a tailgate pull rope hook. The locking system pull rope is connected to the tailgate pull rope hook.

The tailgate is the component that is opened most frequently. Therefore, how to open it conveniently is the key to the tailgate. By setting the pull rope of the locking system, the lock can be easily opened just by pulling the pull rope of the locking system. In addition, by setting the hook of the tailgate pull rope, the pull rope of the locking system can be hung on the hook of the tailgate pull rope, making the whole more tidy.

Furthermore, the storage box is provided with a box body notch. The guide rail passes through the box body notch. The front cover is provided with a fixing hole for the front cover and the guide rail. The fixing hole for the front cover and the guide rail is connected to the guide rail by screws.

Furthermore, the intermediate profile rubber strip assembly includes an intermediate rubber strip, an intermediate profile and a profile joint. The intermediate rubber strip and the intermediate profile are arranged alternately to form the main body of the roll cover. The profile joint is connected to both ends of the main body of the roll cover.

Furthermore, the intermediate rubber strip includes the intermediate rubber strip A, a round hole of the intermediate rubber strip, a concave part of the intermediate rubber strip and the intermediate rubber strip B;

The intermediate rubber strip A and the intermediate rubber strip B are arranged asymmetrically. The intermediate rubber strip A is provided with a round hole of the intermediate rubber strip. The intermediate rubber strip A and the intermediate rubber strip B are connected by the concave part of the intermediate rubber strip.

Since the intermediate profile needs to be connected by the intermediate rubber strip, how to ensure the stable connection of the intermediate rubber strip without falling off. In this application, The intermediate rubber strip A and the intermediate rubber strip B are used for connection, and the intermediate rubber strip A and the intermediate rubber strip B adopt an asymmetric structure. Due to the asymmetry on both sides, the stress points are different when stress is applied on both sides, making the stress more dispersed and prolonging the service life.

Furthermore, the intermediate profile includes a first C-shaped groove of the profile, a profile second hook, a profile first hook, a profile first notch, a fixing hole for the screw of the intermediate profile, a joint part of the plastic part of the intermediate profile, a profile fourth hook, a profile fifth hook, a second C-shaped groove of the profile, a profile second notch and a large plane of the profile;

The two joint parts of the plastic part of the intermediate profile. The two joint parts of the plastic part of the intermediate profile are symmetrically arranged on both sides of the fixing hole for the screw of the intermediate profile. The first C-shaped groove of the profile is provided with the profile first notch. The second C-shaped groove of the profile is provided with a profile second notch. The first C-shaped groove of the profile and the second C-shaped groove of the profile are asymmetrically distributed;

The second C-shaped groove of the profile is provided with a profile first hook and a profile fifth hook. The first C-shaped groove of the profile is provided with a profile second hook and a profile fourth hook. The other side of the intermediate profile is a large plane of the profile.

The intermediate profile is connected with the intermediate rubber strip A and the intermediate rubber strip B through the first C-shaped groove and the second C-shaped groove of the profile. Then, by clamping the second hook of the profile with the fourth hook of the profile and clamping the first hook of the profile with the fifth hook of the profile, the intermediate rubber strip is clamped to achieve connection. Since the intermediate rubber strip A and the intermediate rubber strip B adopt an asymmetric structure, the first C-shaped groove and the second C-shaped groove of the profile also adopt an asymmetric structure to match the intermediate rubber strip A and the intermediate rubber strip B.

In addition, by setting the first notch and the second notch of the profile, when clamping, the bending points are the first notch and the second notch of the profile, which makes the bending points of each intermediate profile the same, thus ensuring the uniform quality of the intermediate profiles.

Furthermore, the profile joint is provided with a first lateral positioning groove of the profile joint, a first lateral protrusion of the profile joint, a connection hole of the profile joint, a profile joint profile connection protrusion, a profile joint bottom surface, a profile joint lateral second protrusion, a profile joint lateral second positioning and a profile side inclined surface;

The first lateral positioning groove of the profile joint is matched with the first lateral protrusion of the profile joint. The profile joint lateral second positioning is matched with the profile joint lateral second protrusion;

The connection hole of the profile joint is arranged in the middle of the profile joint. There are two profile joint profile connection protrusions. The two profile joint profile connection protrusions are symmetrically arranged on both sides of the connection hole of the profile joint. The profile joint bottom surface is a plane. The profile side inclined surface is a sloped surface.

The profile joint is connected to both ends of the intermediate profile rubber strip assembly. Therefore, to ensure the compatibility of the intermediate profile rubber strip assembly with the intermediate rubber strip and the intermediate profile, through the connection hole of the profile joint, the profile joint can be connected with the intermediate profile. At the same time, the connection protrusion of the profile joint exactly snaps into the intermediate profile, thus ensuring the connection stability of the formed joint 23 with the intermediate profile rubber strip assembly.

Furthermore, the connection hole of the profile joint is connected to the fixing hole for the screw of the intermediate profile by screws. The profile joint profile connection protrusion is engaged with the joint part of the plastic part of the intermediate profile.

Furthermore, the intermediate rubber strip A is engaged with the first C-shaped groove of the profile. The intermediate rubber strip B is engaged with the second C-shaped groove of the profile, and through the deformation of the profile to form extrusion waterproofing.

Furthermore, the profile second hook and the profile first hook are in contact, to ensure the installation accuracy.

Beneficial Effects of the Invention: The present invention, by setting the lower sliding strip, using the lower sliding strip to support the intermediate profile rubber strip assembly, and through the design of the structure of the lower sliding strip, makes the intermediate profile rubber strip assembly and the lower sliding strip maintain line contact, thereby ensuring the smooth sliding of the intermediate profile rubber strip assembly. Secondly, by setting the lower blocking waterproof rubber strip, concentrating the rainwater in the guide rail channel can play a good waterproof role.

### DESCRIPTION OF THE DRAWINGS

FIG. 1 is the installation schematic diagram of the present invention.

FIG. 2 is the first structural schematic diagram of the present invention.

FIG. 3 is the second structural schematic diagram of the present invention.

FIG. 4 is the sectional view in the A-A direction of FIG. 3.

FIG. 5 is the partial enlarged view of part B in FIG. 4.

FIG. 6 is the partial enlarged view of part C in FIG. 5.

FIG. 7 is the partial enlarged view of part D in FIG. 5.

FIG. 8 is the first structural schematic diagram of the profile joint in the present invention.

FIG. 9 is the second structural schematic diagram of the profile joint in the present invention.

FIG. 10 is the third structural schematic diagram of the profile joint in the present invention.

FIG. 11 is the third structural schematic diagram of the present invention.

FIG. 12 is the sectional view in the E-E direction of FIG. 11.

FIG. 13 is the partial enlarged view of part F in FIG. 12.

FIG. 14 is the partial enlarged view of part G in FIG. 13.

FIG. 15 is the fourth structural schematic diagram of the present invention.

FIG. 16 is the partial enlarged view of part H in FIG. 15.

FIG. 17 is the fifth structural schematic diagram of the present invention.

FIG. 18 is the partial enlarged view of part I in FIG. 17.

FIG. 19 is the connection schematic diagram of the latch bolt system.

FIG. 20 is the sixth structural schematic diagram of the present invention.

In the figures: 1—Front cover; 1101—Fixing hole for the front cover and guide rail; 2—Intermediate profile rubber strip assembly; 21—Intermediate rubber strip; 2101—Intermediate Rubber Strip A ; 2102—A Round Hole of the Intermediate Rubber Strip; 2103—A Concave Part of the Intermediate Rubber Strip; 2104—Intermediate Rubber Strip B; 22—Intermediate profile; 2201—First C-shaped groove of the profile; 2202—Profile second hook; 2203—Profile first hook; 2204—Profile first notch; 2205—Fixing hole for the screw of the Intermediate profile; 2206—Joint part of the plastic of the intermediate profile; 2207—Profile fourth hook; 2208—Profile fifth hook; 2209—Second C-shaped groove of the profile; 2210—Profile second notch; 2211—Large plane of the profile; 23—Profile joint; 2301—Profile joint lateral first positioning groove; 2302—Profile joint lateral first protrusion; 2303—Connection hole of the profile joint; 2304—Profile joint profile connection protrusion; 2305—Profile joint bottom surface; 2306—Profile joint lateral second protrusion; 2307—Profile joint lateral second positioning groove; 2308—Profile side inclined surface; 3—Tailgate; 32—Tailgate pull rope hook; 4—Latch bolt system; 41—Latch bolt; 42—First lock base; 43—Steel wire; 44—Locking system pull rope; 45—Lock fixing block; 46—Second lock base; 47—Locking block; 5—Clip system; 6—Guide rail system; 61—Guide rail; 6101—Guide rail first slot; 6102—Guide rail second slot; 6103—Guide rail support plane; 6104—Guide rail channel; 6105—Guide rail C-profile; 6106—Internal drainage hole of the guide rail; 6107—External drainage hole of the guide rail; 62—Upper blocking waterproof rubber strip; 6201—Rubber strip bottom; 6202—Rubber strip tip; 63—Lower sliding strip; 6301—Lower sliding strip snapping protrusion; 6302—Lower sliding strip contact point; 64—Lower blocking waterproof rubber strip; 6401—Lower blocking waterproof rubber strip inclined piece; 65—Guide rail bottom rubber strip; 66—Guide rail rear joint; 6601—Guide rail rear joint locking groove; 6602—Guide rail rear joint insertion block; 6603—Guide rail rear joint cavity; 6604—Guide rail rear joint second insertion block; 7—Storage box; 7101—Box body notch.

### SPECIFIC IMPLEMENTATION MODES

The present invention will be further elaborated below in combination with the drawings and drawing marks.

In order to understand the above-mentioned purposes, features and advantages of the present invention more clearly, the present invention will be described in detail below in combination with the drawings and specific implementation examples. It should be noted that, in the absence of conflict, the implementation examples of the present application and the features in the implementation examples can be combined with each other.

The terms “first”, “second”, “third”, etc. are only used for distinguishing descriptions and cannot be understood as indicating or implying relative importance.

In the description of the present invention, it should also be noted that, unless otherwise clearly stipulated and limited, the terms “set”, “install”, “connected”, “connecting” should be understood in a broad sense. For example, it can be a fixed connection, a detachable connection, or an integral connection; it can be a mechanical connection or an electrical connection; it can be directly connected or indirectly connected through an intermediate medium, and it can also be the internal communication of two elements. For ordinary technicians in the field, the specific meanings of the above terms in the present invention can be understood according to specific situations.

The specific implementation modes of the present invention will be described in detail below in combination with the drawings. It should be understood that the specific implementation modes described here are only used for illustrating and explaining the present invention and are not used for limiting the present invention.

### Example 1

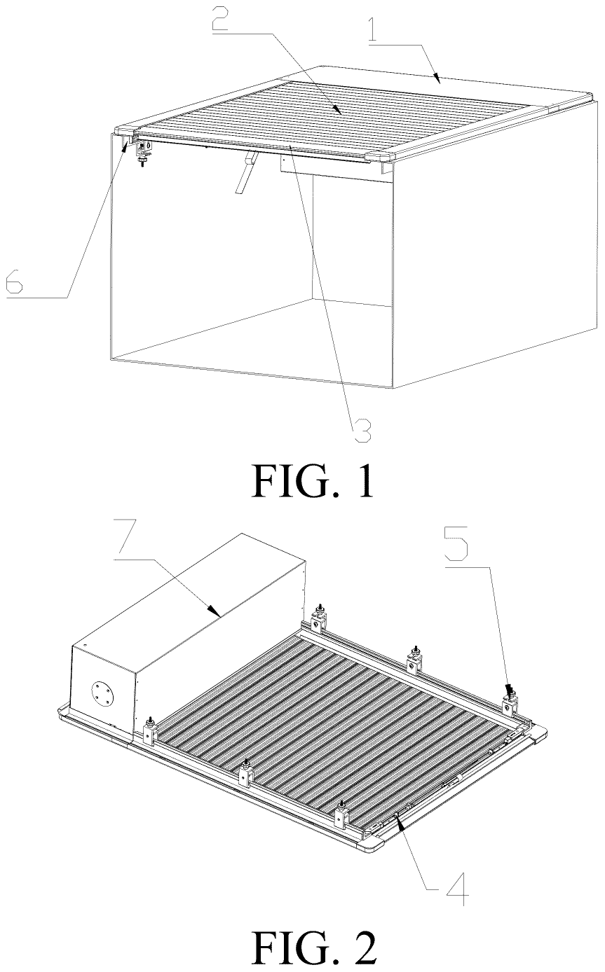

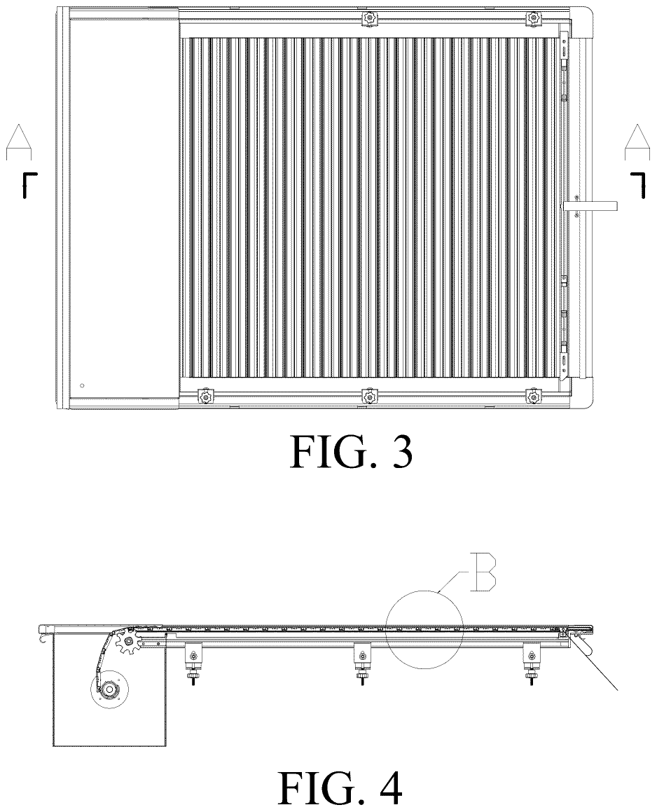

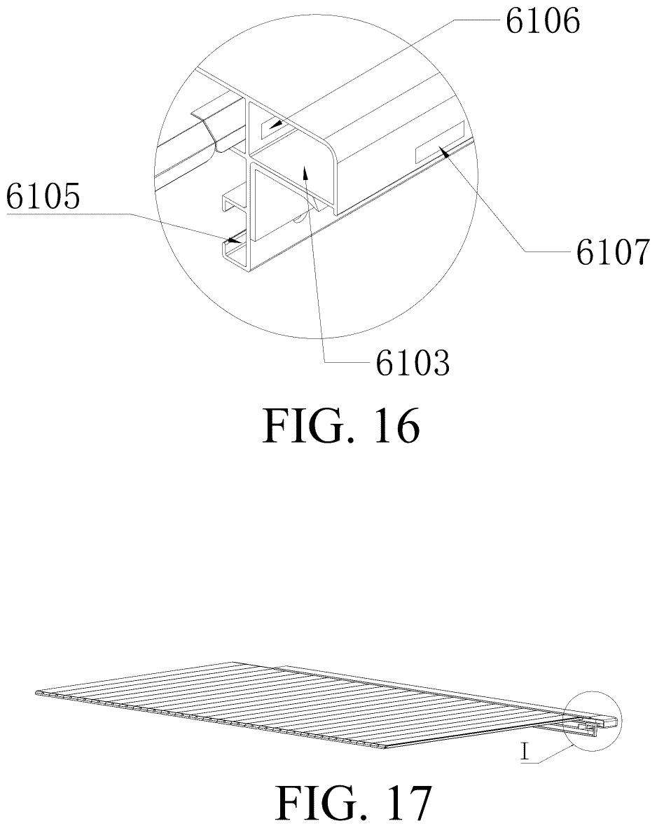

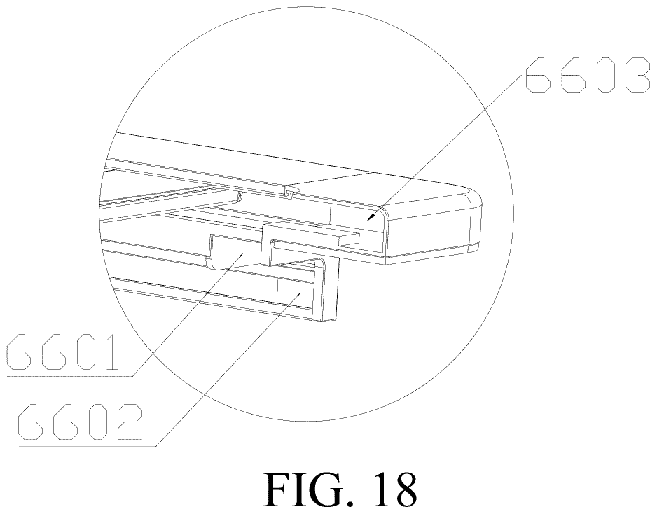

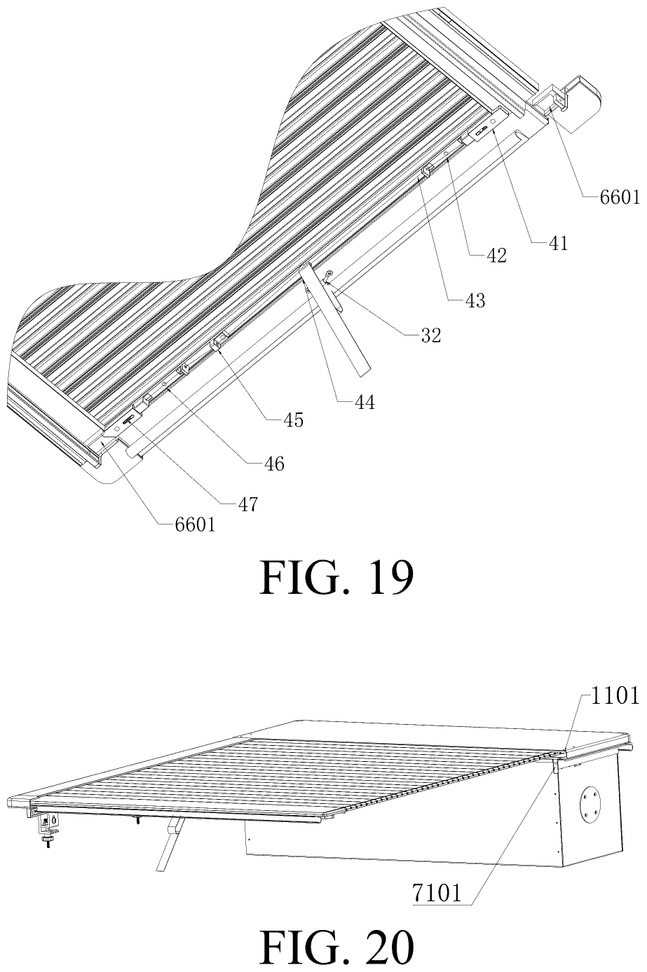

As shown in FIGS. 1, 2, 16 and 17, an aluminum roll cover, it comprises a front cover 1, an intermediate profile rubber strip assembly 2, a tailgate 3, a latch bolt system 4, a clip system 5, a guide rail system 6 and a storage box 7;

The front cover 1 is arranged on the upper side of the storage box 7. The latch bolt system 4 is connected to the front cover 1. The intermediate profile rubber strip assembly 2 is connected to the storage box 7. The tailgate 3 is connected to the tail of the intermediate profile rubber strip assembly 2. The latch bolt system 4 is connected to the tailgate 3. The guide rail system 6 is connected with a clip system 5, and the clip system 5 is used to clamp the body of the pickup truck and the guide rail system 6;

The guide rail system 6 includes a guide rail rear joint 66. The guide rail rear joint 66 is provided with a lock groove of the rear joint of the guide rail 6601. The guide rail rear joint locking groove 6601 is used to cooperate with the latch bolt system 4. The latch bolts 41 of the latch bolt system 4 are distributed at both ends, and at least one latch bolt 41 is provided with a chamfered structure.

The guide rail rear joint 66 is also provided with a guide rail rear joint cavity 6603, and a limit block is arranged on the guide rail rear joint cavity 6603 for limiting the truck cover.

When the latch bolt system 4 snaps into the guide rail rear joint locking groove 6601, the truck cover is locked. When the latch bolt system 4 leaves the guide rail rear joint locking groove 6601, the truck cover is unlocked and opened.

By setting the storage box 7, the intermediate profile rubber strip assembly 2 can be rolled up for convenient storage.

By setting the guide rail rear joint locking groove 6601 in the guide rail system 6, the latch bolt system 4 can be snapped into the guide rail rear joint locking groove 6601, facilitating the connection of the tailgate 3. Since the tailgate 3 needs to be opened and closed frequently, this connection method not only facilitates the opening and closing of the tailgate 3 but also makes the connection of the tailgate 3 stable.

### Example 2

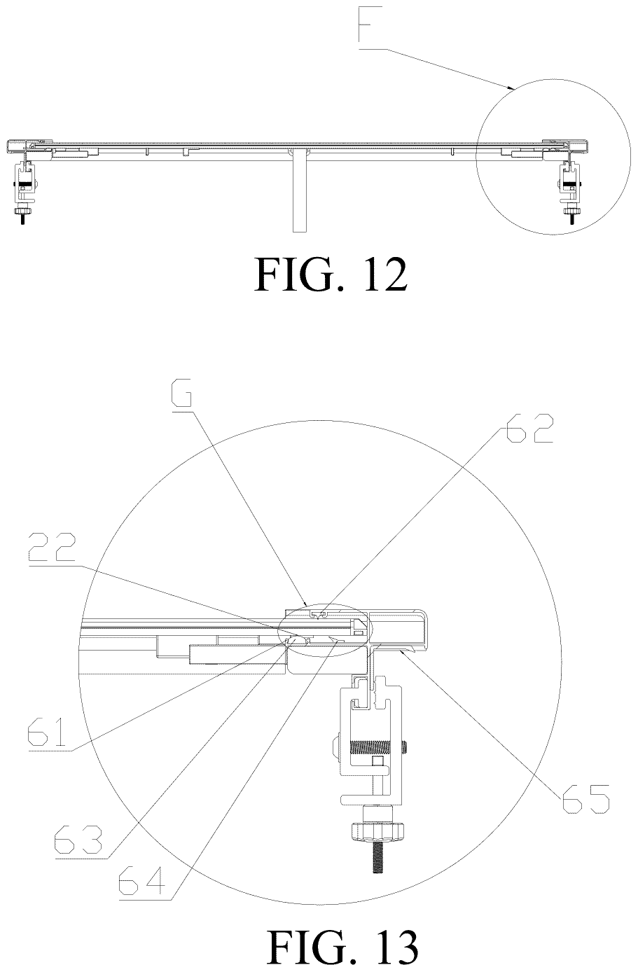

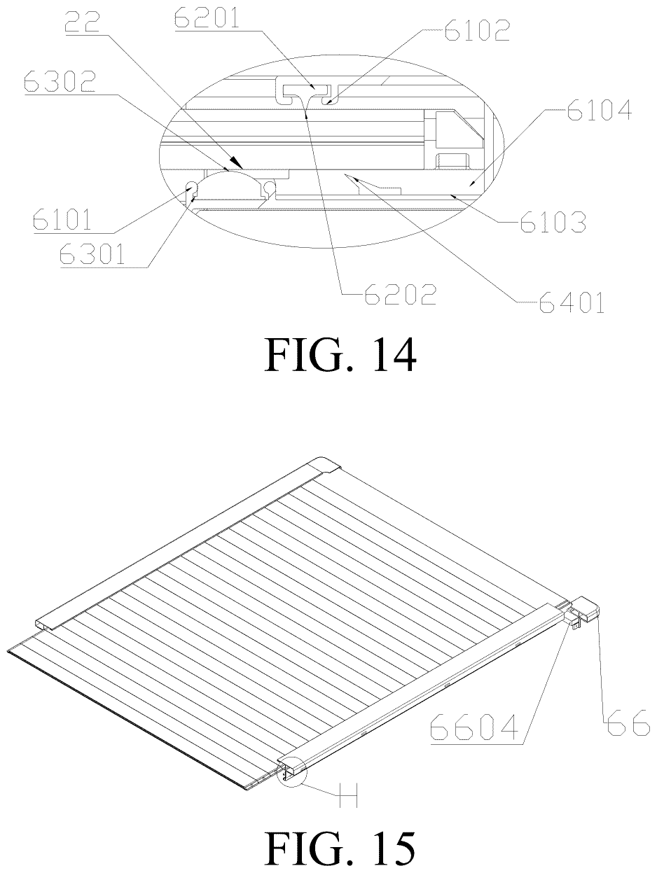

As shown in FIGS. 1, 2, 12-17 , an aluminum roll cover, it comprises a front cover 1, an intermediate profile rubber strip assembly 2, a tailgate 3, a latch bolt system 4, a clip system 5, a guide rail system 6 and a storage box 7;

The front cover 1 is arranged on the upper side of the storage box 7. The latch bolt system 4 is connected to the front cover 1. The intermediate profile rubber strip assembly 2 is connected to the storage box 7. The tailgate 3 is connected to the tail of the intermediate profile rubber strip assembly 2. The latch bolt system 4 is connected to the tailgate 3. The guide rail system 6 is connected with a clip system 5, and the clip system 5 is used to clamp the body of the pickup truck and the guide rail system 6;

The guide rail system 6 includes a guide rail 61 and a guide rail rear joint 66. The guide rail 61 is provided with a guide rail C-profile 6105, an internal drainage hole of the guide rail 6106, and an external drainage hole of the guide rail 6107. The internal drainage hole of the guide rail 6106 and the external drainage hole of the guide rail 6107 are used for drainage. The guide rail rear joint 66 is provided with a guide rail rear joint locking groove 6601 and a guide rail rear joint insertion block 6602. The guide rail rear joint insertion block 6602 is connected to the guide rail C-profile 6105. The guide rail rear joint locking groove 6601 is used to cooperate with the latch bolt system 4.

When the locking league system 4 snaps into the guide rail rear joint locking groove 6601, the truck cover is locked. When the locking league system 4 leaves the guide rail rear joint locking groove 6601, the truck cover is unlocked and opened

By setting the internal drainage hole of the guide rail 6106 and the external drainage hole of the guide rail 6107, the water inside the guide rail 61 can be drained in a timely manner. Additionally, by connecting the guide rail rear joint insertion block 6602 with the guide rail C-profile 6105, the stability of the connection of the guide rail rear joint 66 can be improved.

### Example 3

As shown in FIGS. 1, 2, 12-17 , an aluminum roll cover, it comprises a front cover 1, an intermediate profile rubber strip assembly 2, a tailgate 3, a latch bolt system 4, a clip system 5, a guide rail system 6 and a storage box 7;

The front cover 1 is arranged on the upper side of the storage box 7. The latch bolt system 4 is connected to the front cover 1. The intermediate profile rubber strip assembly 2 is connected to the storage box 7. The tailgate 3 is connected to the tail of the intermediate profile rubber strip assembly 2. The latch bolt system 4 is connected to the tailgate 3. The guide rail system 6 is connected with a clip system 5, and the clip system 5 is used to clamp the body of the pickup truck and the guide rail system 6;

The guide rail system 6 includes a guide rail 61, a guide rail rear joint 66, a lower sliding strip 63, an upper blocking waterproof rubber strip 62 and a lower blocking waterproof rubber strip 64. The guide rail 61 is provided with a guide rail first slot 6101, a guide rail second slot 6102, a guide rail support plane 6103, a guide rail channel 6104 and a guide rail C-profile 6105. The guide rail rear joint 66 is provided with a guide rail rear joint insertion block 6602. The guide rail rear joint insertion block 6602 is connected to the guide rail C-profile 6105. The guide rail second slot 6102 is connected with an upper blocking waterproof rubber strip 62. The guide rail first slot 6101 is connected with a lower sliding strip 63. The guide rail support plane 6103 is connected with a lower blocking waterproof rubber strip 64. The lower blocking waterproof rubber strip 64 and the guide rail support plane 6103 form a guide rail channel 6104.

By setting the lower sliding strip 63, using the lower sliding strip 63 to support the intermediate profile rubber strip assembly 2, and through the design of the structure of the lower sliding strip 63, the intermediate profile rubber strip assembly 2 and the lower sliding strip 63 maintain line contact, thereby ensuring the smooth sliding of the intermediate profile rubber strip assembly 2. Secondly, by setting the lower blocking waterproof rubber strip 64, concentrating the rainwater in the guide rail channel 6104 can play a good waterproof role.

### Example 4

Based on Example 3, the upper blocking waterproof rubber strip 62 includes a rubber strip bottom 6201 and a rubber strip tip 6202. The rubber strip bottom 6201 is engaged with the guide rail second slot 6102. The rubber strip tip 6202 is used for waterproofing;

The intermediate profile rubber strip assembly 2 includes multiple intermediate profiles 22. The lower sliding strip 63 further includes a lower sliding strip snapping protrusion 6301 and a lower sliding strip contact point 6302. The lower sliding strip snapping protrusion 6301 is engaged with the guide rail first slot 6101. The lower sliding strip contact point 6302 abuts against the intermediate profile 22 and is used for slidingly supporting the vehicle cover. The contact between the lower sliding strip contact point 6302 and the intermediate profile 22 is a line contact;

The lower blocking waterproof rubber strip 64 is connected to the guide rail support plane 6103. The lower blocking waterproof rubber strip 64 is used to prevent water from flooding into the interior of the vehicle cover from the guide rail channel 6104. The lower blocking waterproof rubber strip 64 is provided with a lower blocking waterproof rubber strip inclined piece 6401. The lower blocking waterproof rubber strip inclined piece 6401 inclines towards the inside of the pickup truck body, and the lower blocking waterproof rubber strip inclined piece 6401 can be closely attached to the truck cover to improve the waterproof effect.

Since the lower sliding strip 63 is to support the intermediate profile rubber strip assembly 2, and the lower sliding strip 63 serves as a transition piece between the guide rail 61 and the intermediate profile rubber strip assembly 2, with one side being the fixed guide rail 61 and the other side being the sliding intermediate profile rubber strip assembly 2, in order to ensure the stability of the connection of the lower sliding strip 63, a lower sliding strip snapping protrusion 6301 is specially set at its bottom. In this way, the lower sliding strip 63 is not easy to fall off after being snapped into the guide rail first slot 6101, thus prolonging the service life.

In addition, an upper blocking waterproof rubber strip 62 is also set on the upper side of the intermediate profile rubber strip assembly 2, and the upper blocking waterproof rubber strip 62 has a rubber strip tip 6202 protruding towards the intermediate profile rubber strip assembly 2. The rubber strip tip 6202 abuts against the intermediate profile rubber strip assembly 2, which can play a good waterproof effect.

### Example 5

Based on Examples 1-3, the guide rail system 6 includes a guide rail 61. The guide rail 61 includes a guide rail support plane 6103, an internal drainage hole of the guide rail 6106 and an external drainage hole of the guide rail 6107. The internal drainage hole of the guide rail 6106 and the external drainage hole of the guide rail 6107 are both arranged on the upper side of the guide rail support plane 6103.

The guide rail system 6 includes the guide rail C-profile 6105 connected to the pickup truck body at the lower part, and also includes the upper half part for its waterproofing and supporting functions. Through the improvement of the overall cross-section of the guide rail system 6, it has both the functions of connection and waterproofing.

The guide rail 61 includes an internal drainage hole of the guide rail 6106. The guide rail rear joint 66 is provided with a guide rail joint second insertion block 6604. The guide rail joint second insertion block 6604 is connected to the guide rail 61.

The guide rail 61 is also connected with a guide rail bottom rubber strip 65. The guide rail bottom rubber strip 65 is placed between the clip system 5 and the guide rail 61. On the one hand, it increases the friction force, and on the other hand, it prevents the wear of the guide rail.

### Example 6

Based on Examples 1-3, as shown in FIG. 20, the latch bolt system 4 includes a latch bolt 41, a first lock base 42, a steel wire 43, a locking system pull rope 44, a lock fixing block 45, a second lock base (46) and a locking block 47;

Both the latch bolt 41 and the locking block 47 are connected to the guide rail rear joint locking groove 6601. The latch bolt 41, the first lock base 42, the locking system pull rope 44 and the lock fixing block 45 are connected in series by the steel wire 43; the locking system pull rope 44 is pulled, the latch bolt 41 and the locking block 47 can be opened.

The tailgate 3 is provided with a tailgate pull rope hook 32. The locking system pull rope 44 is connected to the tailgate pull rope hook 32.

The tailgate 3 is the component that is opened most frequently. Therefore, how to open it conveniently is the key to the tailgate. By setting the locking system pull rope 44, the lock can be easily opened just by pulling the locking system pull rope 44. In addition, by setting the tailgate pull rope hook 32, the locking system pull rope 44 can be hung on the tailgate pull rope hook 32, making the whole more tidy.

### Example 7

Based on Examples 1-3, as shown in FIG. 21, the storage box 7 is provided with a box body notch 7101. The guide rail 61 passes through the box body notch 7101. The front cover 1 is provided with a fixing hole for the front cover and the guide rail 1101. The fixing hole for the front cover and the guide rail 1101 is connected to the guide rail 61 by screws.

### Example 9

Based on Examples 1-3, the intermediate profile rubber strip assembly 2 includes an intermediate rubber strip 21, an intermediate profile 22 and a profile joint 23. The intermediate rubber strip 21 and the intermediate profile 22 are arranged alternately to form the main body of the roll cover. The profile joint 23 is connected to both ends of the main body of the roll cover.

### Example 10

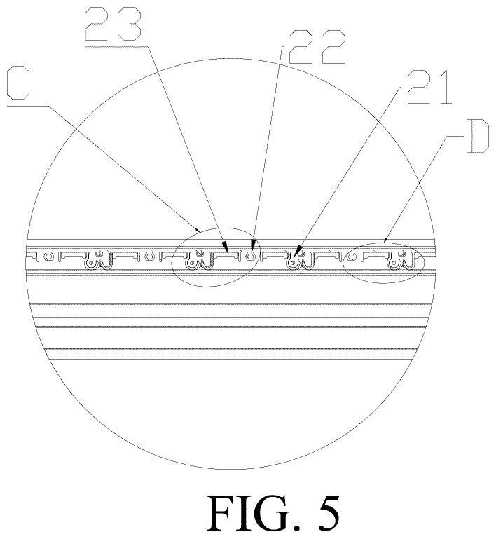

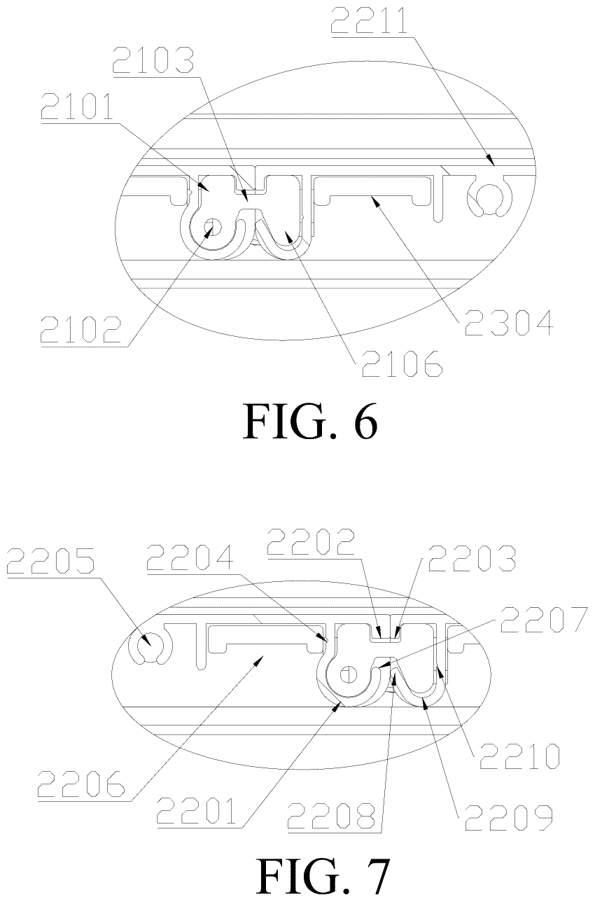

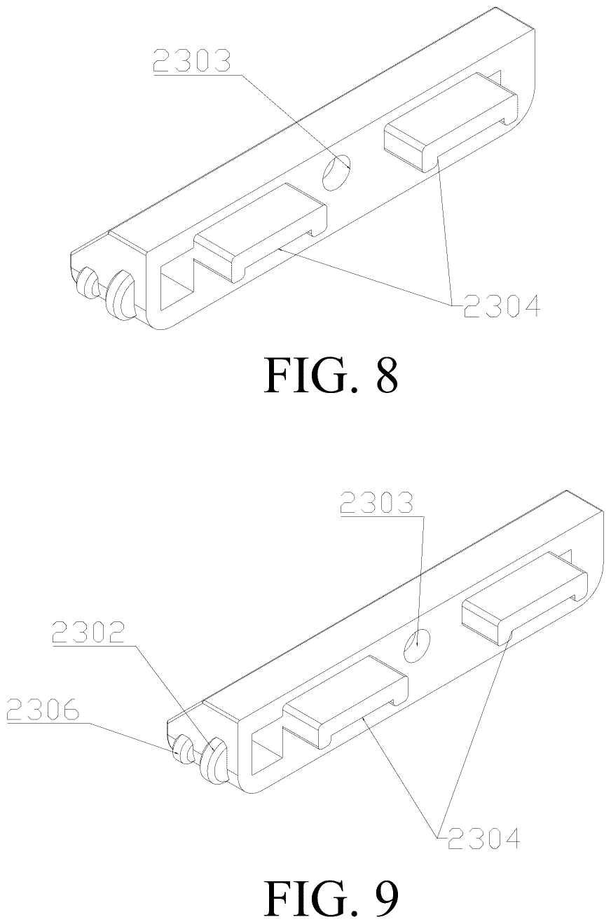

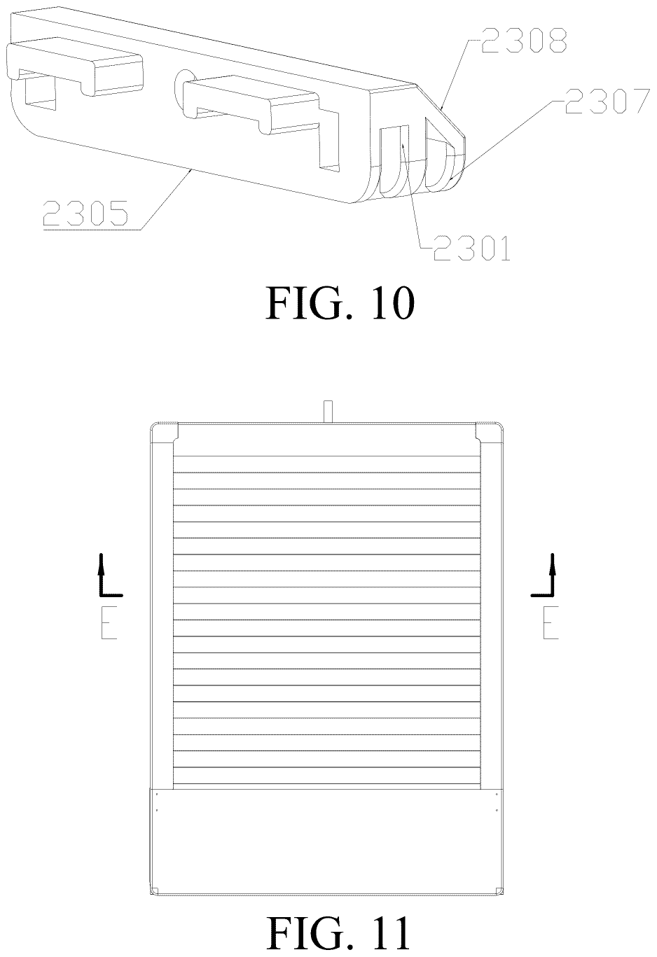

Based on Example 9, as shown in FIGS. 4-11 , the intermediate rubber strip 21 includes the intermediate rubber strip A 2101, a round hole of the intermediate rubber strip 2102, a concave part of the intermediate rubber strip 2103 and the intermediate rubber strip B 2104;

The intermediate rubber strip A 2101 and the intermediate rubber strip B 2104 are arranged asymmetrically. The intermediate rubber strip A 2101 is provided with a round hole of the intermediate rubber strip 2102. The intermediate rubber strip A 2101 and the intermediate rubber strip B 2104 are connected by the concave part of the intermediate rubber strip 2103.

Since the intermediate profile 22 needs the intermediate rubber strip 21 for connection, how to ensure the stable connection of the intermediate rubber strip 21 without falling off. In this application, the intermediate rubber strip A 2101 and the intermediate rubber strip B 2104 are used for connection, and the intermediate rubber strip A 2101 and the intermediate rubber strip B 2104 adopt an asymmetric structure (the asymmetric structure mentioned here mainly means that the structures of the intermediate rubber strip A 2101 and the intermediate rubber strip B 2104 are different). Due to the asymmetry on both sides, the stress points are different when stress is applied on both sides, making the stress more dispersed and prolonging the service life.

Finally, on the intermediate rubber strip A 2101, a round hole of the intermediate rubber strip 2102 is set, so that the intermediate rubber strip A 2101 has a certain compression space, enabling the intermediate rubber strip A 2101 to be clamped more tightly and the connection to be more firm.

### Example 11

Based on Example 9, as shown in FIGS. 4-11 , the intermediate profile 22 includes a first C-shaped groove of the profile 2201, a profile second hook 2202, a profile first hook 2203, a profile first notch 2204, a fixing hole for the screw of the intermediate profile 2205, a joint part of the plastic part of the intermediate profile 2206, a profile fourth hook 2207, a profile fifth hook 2208, a second C-shaped groove of the profile 2209, a profile second notch 2210 and a large plane of the profile 2211;

The two joint parts of the plastic part of the intermediate profile 2206. The two joint parts of the plastic part of the intermediate profile 2206 are symmetrically arranged on both sides of the fixing hole for the screw of the intermediate profile 2205. The first C-shaped groove of the profile 2201 is provided with the profile first notch 2204. The second C-shaped groove of the profile 2209 is provided with a profile second notch 2210. The first C-shaped groove of the profile 2201 and the second C-shaped groove of the profile 2209 are asymmetrically distributed;

The second C-shaped groove of the profile 2209 is provided with a profile first hook 2203 and a profile fifth hook 2208. The first C-shaped groove of the profile 2201 is provided with a profile second hook 2202 and a profile fourth hook 2207. The other side of the intermediate profile 22 is a large plane of the profile 2211.

The intermediate profile 22 through the first C-shaped groove of the profile 2201 and the second C-shaped groove of the profile 2209 is connected with the intermediate rubber strip A 2101 and the intermediate rubber strip B 2104. Then, by clamping the profile second hook 2202 with the profile fourth hook 2207 and clamping the profile first hook 2203 with the profile fifth hook 2208, the intermediate rubber strip 21 is clamped to achieve connection. Since the intermediate rubber strip A 2101 and the intermediate rubber strip B 2104 adopt an asymmetric structure, the first C-shaped groove of the profile 2201 and the second C-shaped groove of the profile 2209 also adopt an asymmetric structure to match the intermediate rubber strip A 2101 and the intermediate rubber strip B 2104.

In addition, by setting the profile first notch 2204 and the profile second notch 2210, when clamping, the bending points are the profile first notch 2204 and the profile second notch 2210, so that the bending points of each intermediate profile 22 are the same, thus ensuring the uniform quality of the intermediate profile 22.

### Example 12

Based on Example 9, as shown in FIGS. 4-11 , the profile joint 23 is provided with a first lateral positioning groove of the profile joint 2301, a first lateral protrusion of the profile joint 2302, a connection hole of the profile joint 2303, a profile joint profile connection protrusion 2304, a profile joint bottom surface 2305, a profile joint lateral second protrusion 2306, a profile joint lateral second positioning 2307 and a profile side inclined surface 2308;

The first lateral positioning groove of the profile joint 2301 is matched with the first lateral protrusion of the profile joint 2302. The profile joint lateral second positioning 2307 is matched with the profile joint lateral second protrusion 2306;

The connection hole of the profile joint 2303 is arranged in the middle of the profile joint 23. There are two profile joint profile connection protrusions 2304. The two profile joint profile connection protrusions 2304 are symmetrically arranged on both sides of the connection hole of the profile joint 2303. The profile joint bottom surface 2305 is a plane. The profile side inclined surface 2308 is a sloped surface.

The profile joint is connected to both ends of the intermediate profile rubber strip assembly 2. Therefore, to ensure the compatibility of the intermediate profile rubber strip assembly 2 with the intermediate rubber strip 21, the intermediate profile 22, through the connection hole of the profile joint 2303, the profile joint 23 can be connected with the intermediate profile 22. At the same time, the profile joint profile connection protrusion 2304 exactly snaps into the intermediate profile 22, thus ensuring the connection stability of the formed joint 23 with the intermediate profile rubber strip assembly 2.

### Example 13

Based on Examples 10-12, the connection hole of the profile joint 2303 is connected to the fixing hole for the screw of the intermediate profile 2205 by screws. The profile joint profile connection protrusion 2304 is engaged with the joint part of the plastic part of the intermediate profile 2206.

### Example 14

Based on Examples 10-12, the intermediate rubber strip A 2101 is engaged with the first C-shaped groove of the profile 2201. The intermediate rubber strip B 2104 is engaged with the second C-shaped groove of the profile 2209, and through the deformation of the profile to form extrusion waterproofing. Specifically, with the profile first hook 2203 and the profile fifth hook 2208 by clamping and squeezing the concave part of the intermediate rubber strip 2103. Similarly, the profile second hook 2202 and the profile fourth hook 2207 squeeze the concave part of the intermediate rubber strip 2103 to achieve this.

### Example 15

Based on Example 1, the profile second hook 2202 and the profile first hook 2203 are in contact, to ensure the installation accuracy.

The present invention is not limited to the above optional implementation modes. Anyone can obtain other various forms of products under the inspiration of the present invention. However, regardless of any changes in its shape or structure, any technical solution that falls within the scope defined by the claims of the present invention is within the protection scope of the present invention.

1. An aluminum roll cover, characterized in that it comprises a front cover (1), an intermediate profile rubber strip assembly (2), a tailgate (3), a latch bolt system (4), a clip system (5), a guide rail system (6) and a storage box (7);
The front cover (1) is arranged on the upper side of the storage box (7). The latch bolt system (4) is connected to the front cover (1). The intermediate profile rubber strip assembly (2) is connected to the storage box (7). The tailgate (3) is connected to the tail of the intermediate profile rubber strip assembly (2). The latch bolt system (4) is connected to the tailgate (3). The guide rail system (6) is connected with a clip system (5), and the clip system (5) is used to clamp the body of the pickup truck and the guide rail system (6);
The guide rail system (6) includes a guide rail rear joint (66). The guide rail rear joint (66) is provided with a lock groove of the rear joint of the guide rail (6601). The guide rail rear joint locking groove (6601) is used to cooperate with the latch bolt system (4). The latch bolts (41) of the latch bolt system (4) are distributed at both ends, and at least one latch bolt (41) is provided with a chamfered structure.

2. An aluminum roll cover, characterized in that it comprises a front cover (1), an intermediate profile rubber strip assembly (2), a tailgate (3), a latch bolt system (4), a clip system (5), a guide rail system (6) and a storage box (7);
The front cover (1) is arranged on the upper side of the storage box (7). The latch bolt system (4) is connected to the front cover (1). The intermediate profile rubber strip assembly (2) is connected to the storage box (7). The tailgate (3) is connected to the tail of the intermediate profile rubber strip assembly (2). The latch bolt system (4) is connected to the tailgate (3). The guide rail system (6) is connected with a clip system (5), and the clip system (5) is used to clamp the body of the pickup truck and the guide rail system (6);
The guide rail system (6) includes a guide rail (61) and a guide rail rear joint (66). The guide rail (61) is provided with a guide rail C-profile (6105), an internal drainage hole of the guide rail (6106), and an external drainage hole of the guide rail (6107). The internal drainage hole of the guide rail (6106) and the external drainage hole of the guide rail (6107) are used for drainage. The guide rail rear joint (66) is provided with a guide rail rear joint locking groove (6601) and a guide rail rear joint insertion block (6602). The guide rail rear joint insertion block (6602) is connected to the guide rail C-profile (6105). The guide rail rear joint locking groove (6601) is used to cooperate with the latch bolt system (4).

3. An aluminum roll cover, characterized in that it comprises a front cover (1), an intermediate profile rubber strip assembly (2), a tailgate (3), a latch bolt system (4), a clip system (5), a guide rail system (6) and a storage box (7);
The front cover (1) is arranged on the upper side of the storage box (7). The latch bolt system (4) is connected to the front cover (1). The intermediate profile rubber strip assembly (2) is connected to the storage box (7). The tailgate (3) is connected to the tail of the intermediate profile rubber strip assembly (2). The latch bolt system (4) is connected to the tailgate (3). The guide rail system (6) is connected with a clip system (5), and the clip system (5) is used to clamp the body of the pickup truck and the guide rail system (6);
The guide rail system (6) includes a guide rail (61), a guide rail rear joint (66), a lower sliding strip (63), an upper blocking waterproof rubber strip (62) and a lower blocking waterproof rubber strip (64). The guide rail (61) is provided with a guide rail first slot (6101), a guide rail second slot (6102), a guide rail support plane (6103), a guide rail channel (6104) and a guide rail C-profile (6105). The guide rail rear joint (66) is provided with a guide rail rear joint insertion block (6602). The guide rail rear joint insertion block (6602) is connected to the guide rail C-profile (6105). The guide rail second slot (6102) is connected with an upper blocking waterproof rubber strip (62). The guide rail first slot (6101) is connected with a lower sliding strip (63). The guide rail support plane (6103) is connected with a lower blocking waterproof rubber strip (64). The lower blocking waterproof rubber strip (64) and the guide rail support plane (6103) form a guide rail channel (6104).

4. The aluminum roll cover according to claim 3, characterized in that: the upper blocking waterproof rubber strip (62) includes a rubber strip bottom (6201) and a rubber strip tip (6202). The rubber strip bottom (6201) is engaged with the guide rail second slot (6102). The rubber strip tip (6202) is used for waterproofing;
The intermediate profile rubber strip assembly (2) includes multiple intermediate profiles (22). The lower sliding strip (63) further includes a lower sliding strip snapping protrusion (6301) and a lower sliding strip contact point (6302). The lower sliding strip snapping protrusion (6301) is engaged with the guide rail first slot (6101). The lower sliding strip contact point (6302) abuts against the intermediate profile (22) and is used for slidingly supporting the vehicle cover. The contact between the lower sliding strip contact point (6302) and the intermediate profile (22) is a line contact;
The lower blocking waterproof rubber strip (64) is connected to the guide rail support plane (6103). The lower blocking waterproof rubber strip (64) is used to prevent water from flooding into the interior of the vehicle cover from the guide rail channel (6104).

5. The aluminum roll cover according to any one of claims 1-3, characterized in that: the guide rail system (6) includes a guide rail (61). The guide rail (61) includes a guide rail support plane (6103), an internal drainage hole of the guide rail (6106) and an external drainage hole of the guide rail (6107). The internal drainage hole of the guide rail (6106) and the external drainage hole of the guide rail (6107) are both arranged on the upper side of the guide rail support plane (6103).

6. The aluminum roll cover according to any one of claims 1-3, characterized in that: the guide rail (61) includes an internal drainage hole of the guide rail (6106). The guide rail rear joint (66) is provided with a guide rail joint second insertion block (6604). The guide rail joint second insertion block (6604) is connected to the guide rail (61).

7. The aluminum roll cover according to any one of claims 1-3, characterized in that: the latch bolt system (4) includes a latch bolt (41), a first lock base (42), a steel wire (43), a locking system pull rope (44), a lock fixing block (45), a second lock base (46) and a locking block (47);
Both the latch bolt (41) and the locking block (47) are connected to the guide rail rear joint locking groove (6601). The latch bolt (41), the first lock base (42), the locking system pull rope (44) and the lock fixing block (45) are connected in series by the steel wire (43);
The tailgate (3) is provided with a tailgate pull rope hook (32). The locking system pull rope (44) is connected to the tailgate pull rope hook (32).

8. The aluminum roll cover according to any one of claims 1-3, characterized in that: the storage box (7) is provided with a box body notch (7101). The guide rail (61) passes through the box body notch (7101). The front cover (1) is provided with a fixing hole for the front cover and the guide rail (1101). The fixing hole for the front cover and the guide rail (1101) is connected to the guide rail (61) by screws.

9. The aluminum roll cover according to any one of claims 1-3, characterized in that: the intermediate profile rubber strip assembly (2) includes an intermediate rubber strip (21), an intermediate profile (22) and a profile joint (23). The intermediate rubber strip (21) and the intermediate profile (22) are arranged alternately to form the main body of the roll cover. The profile joint (23) is connected to both ends of the main body of the roll cover.

10. The aluminum roll cover according to any one of claims 1-3, characterized in that: the intermediate rubber strip (21) includes the intermediate rubber strip A (2101), a round hole of the intermediate rubber strip (2102), a concave part of the intermediate rubber strip (2103) and the intermediate rubber strip B (2104);
The intermediate rubber strip A (2101) and the intermediate rubber strip B (2104) are arranged asymmetrically. The intermediate rubber strip A (2101) is provided with a round hole of the intermediate rubber strip (2102). The intermediate rubber strip A (2101) and the intermediate rubber strip B (2104) are connected by the concave part of the intermediate rubber strip (2103).

11. The aluminum roll cover according to claim 9, characterized in that: the intermediate profile (22) includes a first C-shaped groove of the profile (2201), a profile second hook (2202), a profile first hook (2203), a profile first notch (2204), a fixing hole for the screw of the intermediate profile (2205), a joint part of the plastic part of the intermediate profile (2206), a profile fourth hook (2207), a profile fifth hook (2208), a second C-shaped groove of the profile (2209), a profile second notch (2210) and a large plane of the profile (2211);
The two joint parts of the plastic part of the intermediate profile (2206). The two joint parts of the plastic part of the intermediate profile (2206) are symmetrically arranged on both sides of the fixing hole for the screw of the intermediate profile (2205). The first C-shaped groove of the profile (2201) is provided with the profile first notch (2204). The second C-shaped groove of the profile (2209) is provided with a profile second notch (2210). The first C-shaped groove of the profile (2201) and the second C-shaped groove of the profile (2209) are asymmetrically distributed;
The second C-shaped groove of the profile (2209) is provided with a profile first hook (2203) and a profile fifth hook (2208). The first C-shaped groove of the profile (2201) is provided with a profile second hook (2202) and a profile fourth hook (2207). The other side of the intermediate profile (22) is a large plane of the profile (2211).

12. The aluminum roll cover according to claim 9, characterized in that: the profile joint

(23) is provided with a first lateral positioning groove of the profile joint (2301), a first lateral protrusion of the profile joint (2302), a connection hole of the profile joint (2303), a profile joint profile connection protrusion (2304), a profile joint bottom surface (2305), a profile joint lateral second protrusion (2306), a profile joint lateral second positioning (2307) and a profile side inclined surface (2308);
The first lateral positioning groove of the profile joint (2301) is matched with the first lateral protrusion of the profile joint (2302). The profile joint lateral second positioning (2307) is matched with the profile joint lateral second protrusion (2306);
The connection hole of the profile joint (2303) is arranged in the middle of the profile joint (23). There are two profile joint profile connection protrusions (2304). The two profile joint profile connection protrusions (2304) are symmetrically arranged on both sides of the connection hole of the profile joint (2303). The profile joint bottom surface (2305) is a plane. The profile side inclined surface (2308) is a sloped surface.

13. The aluminum roll cover according to claim 12, characterized in that: the connection hole of the profile joint (2303) is connected to the fixing hole for the screw of the intermediate profile (2205) by screws. The profile joint profile connection protrusion (2304) is engaged with the joint part of the plastic part of the intermediate profile (2206).

14. The aluminum roll cover according to claim 10, characterized in that: The intermediate rubber strip A (2101) is engaged with the first C-shaped groove of the profile (2201). The intermediate rubber strip B (2104) is engaged with the second C-shaped groove of the profile (2209).

15. The aluminum roll cover according to claim 1, characterized in that: the profile second hook (2202) and the profile first hook (2203) are in contact.
